(19) United States
(12) Patent Application Publication
(10) Pub. No.: US 2026/0299842 A1
(43) Pub. Date: Oct. 1, 2026

(54) IMAGE READING APPARATUS CAPABLE OF NOTIFYING VARIETY OF SUPPORTED CAPABILITIES, INFORMATION PROCESSING APPARATUS, IMAGE PROCESSING SYSTEM, AND CONTROL METHODS

(71) Applicant: CANON KABUSHIKI KAISHA, Tokyo (JP)

(72) Inventor: KENJI KASUYA, Kanagawa (JP)

(21) Appl. No.: 19/573,223

(22) Filed: Mar. 20, 2026

(30) Foreign Application Priority Data
Mar. 27, 2025 (JP) 2025-053179

(51) Int. Cl. G06F 3/12

(52) U.S. Cl. CPC G06F 3/1205; G06F 3/1245

(57) ABSTRACT

MFP reads an image according to an instruction received from an information terminal and including a reading setting designated by a user according to capabilities information of the MFP. First and second images converted in a first format and a second output format more restricted in reading settings than the first output format are generated from the read image. If a setting of permission of use of the second output format is received, second capabilities information including a second reading profile formed by reading settings usable in the second output format is transmitted to the information terminal. If the first output format is set in the instruction, the first image is generated, whereas if the second output format is set in the instruction, the second image is generated.

### BACKGROUND

### Field of the Technology

The present disclosure relates to an image reading apparatus that is capable of notifying a variety of supported capabilities, an information processing apparatus, an image processing system, a control method, and a program, and particularly to an image reading apparatus that reads an image in a plurality of output formats, an information processing apparatus that designates a reading setting, an image processing system, and control methods.

### Description of the Related Art

In recent years, a communication protocol used between apparatuses on a network has been standardized in accordance with the increase of network-enabled devices. Specifications of a variety of services, such as a printer (printing)/scanner (image reading) of a multi-function peripheral (MFP), are no exception, and, for example, a communication protocol formed by standardizing an extended simple control language (eSCL) is used.

The eSCL is a protocol of a hypertext transfer protocol (HTTP)-based simple control language, which is mainly used for communication with apparatuses, such as printers and scanners. By using the eSCL, it is possible to use the above-mentioned variety of services from an information processing apparatus, e.g. an information terminal, such as a smartphone, via a network, such as a local area network (LAN) and Wi-Fi. Further, the eSCL functions as a standard protocol which is interoperable between devices of different vendors. Specifically, the information terminal can transmit operations, such as transmission of a print job, start of a scan job, acquisition of a status of a device, and acquisition of capabilities, to the device through a HTTP request. Further, the device can transmit a processing result, status information, capabilities information, and so forth to the information terminal through a HTTP response.

Here, Japanese Laid-Open Patent Publication (Kokai) No. 2005-38016 has proposed a technique for causing an information terminal to recognize services which can be provided by a device connected to the information terminal. In Japanese Laid-Open Patent Publication No. 2005-38016, first, the device acquires information on whether or not a variety of extension apparatuses, such as a hard disk, a finisher, and a double-sided printing apparatus, are attached, and detailed information. Next, the device generates a service specification file according to the acquired information on whether or not a variety of extension apparatuses are attached and detailed information, and transmits the generated service specification file to the information terminal. That is, in Japanese Laid-Open Patent Publication (Kokai) No. 2005-38016, the device dynamically detects whether or not a variety of extension apparatuses are attached, and service contents which can be realized by the device, and transmits the detected information to the information terminal, whereby it is possible to cause the information terminal to recognize services which can be provided by the device.

However, in Japanese Laid-Open Patent Publication (Kokai) No. 2005-38016, although it is possible to cause the information terminal to recognize a change in the services which can be provided by the device, based on whether or not the variety of extension apparatuses are attached, no consideration is given to a case where a service is restricted depending on a combination of a variety of capabilities of the device. For example, in a case where the device is an image reading apparatus, with respect to the scan function, the scan resolution which can be set is sometimes restricted depending on a combination of a variety of capabilities supported by the device, such as an output format and a scan option. For example, the scan resolution which can be set is sometimes different between a case where the output format is the normal Portable Document Format (PDF) and a case where the output format is the PDF with optical character recognition (OCR) information (character recognition information). In Japanese Laid-Open Patent Publication (Kokai) No. 2005-38016, even when restriction is caused in the combination of the output format and the scan resolution as described above, it is impossible to notify the information terminal of this restriction from the device. Therefore, there is a case where a user on the information terminal side sets a scan setting of a combination which cannot be executed by the device (restricted for the device). In this case, the device having received an instruction for starting a scan job having this scan setting terminates the job as an error, and hence it is not convenient for a user to use.

### SUMMARY

The present disclosure is directed to providing a mechanism that makes it possible to notify, even when an image reading apparatus which is restricted in combination of a variety of supported capabilities is used, an information processing apparatus of a variety of supported capabilities from the image reading apparatus without contradicting the restriction of the combination.

In a first aspect of the present disclosure, there is provided an image reading apparatus communicably connected to an information processing apparatus, including at least one processor; and a memory storing instructions that, when executed by the at least one processor, causes the at least one processor to function as: a transmission unit configured to transmit capabilities information of the image reading apparatus including a plurality of reading settings, to the information processing apparatus, a reception unit configured to receive an instruction including a reading setting designated by a user according to the capabilities information transmitted by the transmission unit, from the information processing apparatus, an image reading unit configured to execute reading of an image according to the instruction received by the reception unit, a first image generation unit configured to generate a first image converted in a first output format from the read image, a second image generation unit configured to generate a second image converted in a second output format which is a derivative format of the first output format and is more restricted in reading settings than the first output format, from the read image, and a setting receiving unit configured to receive from a user a setting of permission or no permission of use of the second output format with respect to reading of an image executed according to the instruction received by the reception unit, wherein the transmission unit transmits, in a case where the setting received by the setting receiving unit is a setting of no permission of the use of the second output format, first capabilities information including a first reading profile formed by reading settings usable in the first output format, to the information processing apparatus, as the capabilities information, transmits, in a case where the setting received by the setting receiving unit is a setting of permission of the use of the second output format, second capabilities information including a second reading profile formed by reading settings usable in the second output format, to the information processing apparatus, as the capabilities information, generates, in a case where the first output format is set in the instruction received by the reception unit, the first image by the first image generation unit, as a transmission image, and generates, in a case where the second output format is set in the instruction received by the reception unit, the second image by the second image generation unit, as the transmission image.

In a second aspect of the present disclosure, there is provided an information processing apparatus communicably connected to an image reading apparatus, including at least one processor, and a memory storing instructions that, when executed by the at least one processor, causes the at least one processor to function as: capabilities information acquisition unit configured to acquire capabilities information, including a plurality of reading settings, of the image reading apparatus, from the image reading apparatus, a receiving unit configured to receive reading settings designated by a user according to the acquired capabilities information, an instruction transmission unit configured to transmit an instruction including the reading settings received by the receiving unit, to the image reading apparatus, and an image acquisition unit configured to acquire an image generated by the image reading apparatus according to the instruction, from the image reading apparatus, wherein the receiving unit fixes a selectable output format to the first output format and displays reading settings usable in the first output format, in a user- selectable state, in a case where the acquired capabilities information is first capabilities information including a first reading profile formed by reading settings usable in the first output format, and sets the first output format and the second output format as selectable output formats, in a case where the acquired capabilities information is second capabilities information including a second reading profile formed by reading settings usable in a second output format which is a derivative format of the first output format and is more restricted in reading settings than the first output format, and displays the reading settings usable in the second output format in a user selectable state in a case where the second output format is selected.

In a third aspect of the present disclosure, there is provided an image processing system including an image reading apparatus and an information processing apparatus communicably connected to each other, the information processing apparatus including at least one processor, and a memory storing instructions that, when executed by the at least one processor, causes the at least one processor to function as a request unit configured to request capabilities information, including a plurality of reading settings, of the image reading apparatus, to the image reading apparatus, a receiving unit configured to receive reading settings designated by a user according to the capabilities information acquiredby the request unit, and an instruction transmission unit configured to transmit an instruction including the reading settings received by the receiving unit, to the image reading apparatus, the image reading apparatus including at least one processor; and a memory storing instructions that, when executed by the at least one processor, causes the at least one processor to function as a transmission unit configured to transmit capabilities information, including a plurality of reading settings, of the image reading apparatus, to the information processing apparatus, in response to a request by the request unit, a reception unit configured to receive the instruction from the information processing apparatus, an image reading unit configured to execute reading of an image according to the instruction received by the reception unit, a first image generation unit configured to generate a first image converted in the first output format from the read image, a second image generation unit configured to generate a second image converted in a second output format which is a derivative format of the first output format and is more restricted in reading settings than the first output format, from the read image, and a setting receiving unit configured to receive from a user a setting of permission or no permission of use of the second output format with respect to reading of an image executed according to the instruction received by the reception unit, wherein the transmission unit of the image reading apparatus transmits, in a case where the setting received by the setting receiving unit is a setting of no permission of the use of the second output format, first capabilities information including a first reading profile formed by reading settings usable in the first output format, to the information processing apparatus, as the capabilities information, and transmits, in a case where the setting received by the setting receiving unit is a setting of permission of the use of the second output format, second capabilities information including a second reading profile formed by reading settings usable in the second output format, to the information processing apparatus, as the capabilities information; wherein the receiving unit of the information processing apparatus fixes a selectable output format to the first output format and displays reading settings usable in the first output format, in a user- selectable state, in a case where the capabilities information acquired by the request unit is first capabilities information, and sets the first output format and the second output format as selectable output formats, in a case where the capabilities information acquired by the request unit is the second capabilities information, and displays the reading settings usable in the second output format in a user selectable state in a case where the second output format is selected, generates, in a case where the first output format is set in the instruction received by the reception unit, the first image by the first image generation unit, as a transmission image, and generates, in a case where the second output format is set in the instruction received by the reception unit, the second image by the second image generation unit, as the transmission image.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram showing an example of a system configuration according to an embodiment of the present disclosure.

FIG. 2 is a block diagram showing a hardware configuration of an MFP as an image reading apparatus appearing in FIG. 1.

FIG. 3 is a block diagram showing a hardware configuration of an information terminal as an information processing apparatus appearing in FIG. 1.

FIG. 4 is a diagram showing a relationship between output formats and scan resolutions, supported by the MFP in a scan job.

FIGS. 5A to 5C are diagrams each showing an example of a screen displayed on the MFP, for setting whether or not to use PDF with OCR information when mobile scan is performed.

FIG. 6 is a sequence diagram of a process related to a scan job, which is performed by the information terminal and the MFP.

FIG. 7 is a diagram showing an example of a scanner selection screen displayed on a console panel of the information terminal.

FIGS. 8A and 8B are diagrams each showing an example of a scan setting screen displayed on the console panel of the information terminal in a case where it is recognized that the capability of PDF with OCR information at the time of mobile scan is not included.

FIGS. 9A and 9B are diagrams each showing an example of scan resolutions which can be set for each file format, which are displayed on the scan setting screen shown in FIGS. 8A and 8B.

FIG. 10A to 10D are diagrams each showing an example of a scan setting screen displayed on the console panel of the information terminal in a case where it is recognized that the capability of PDF with OCR information at the time of mobile scan is included.

FIG. 11 is a diagram showing an example of capabilities information transmitted from the MFP to the information terminal as a response in a case where it is determined that the use of PDF with OCR information at the time of mobile scan is not permitted.

FIG. 12 is a diagram showing an example of capabilities information transmitted from the MFP to the information terminal as a response in a case where it is determined that the use of PDF with OCR information at the time of mobile scan is permitted.

FIG. 13 is a flowchart of a process related to a scan job, which is performed by the information terminal.

FIG. 14 is a flowchart of a process related to a scan job, which is performed by the MFP.

FIG. 15 is a flowchart of a capabilities notification process performed in a step in FIG. 14.

FIG. 16 is a flowchart of a scan process performed in a step in FIG. 14.

FIG. 17 is a flowchart of an image data transmission process performed in a step in FIG. 14.

### DESCRIPTION OF THE EMBODIMENTS

The present disclosure will now be described in detail below with reference to the accompanying drawings showing embodiments thereof. Note that the present disclosure according to claims is not limited to the embodiments described below. A plurality of features are described in the embodiments, but not all the plurality of features are absolutely essential to the disclosure, and further, the plurality of features can be combined as desired. Further, in the accompanying drawings, the same or similar components are denoted by the same reference numerals, and redundant description is omitted.

An embodiment of the present disclosure will be described below based on drawings.

The embodiment of the present disclosure will be described below with reference to the drawings. Note that configurations described in the following embodiment are given only by way of example, and the illustrated configurations are by no means intended to limit the scope of the present disclosure.

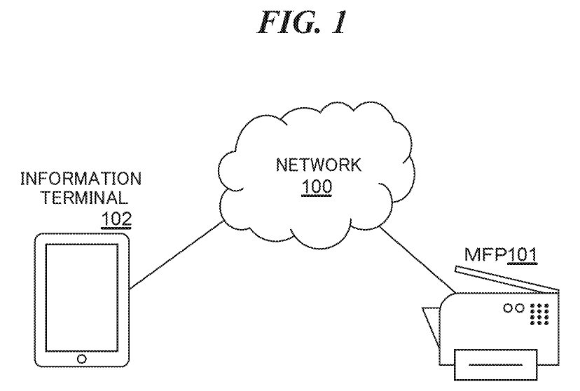

FIG. 1 is a diagram showing an example of a system configuration according to an embodiment of the present disclosure. The system configuration of the present embodiment shows an example of an image processing system which is formed by communicably connecting an MFP 101 (image reading apparatus) and an information terminal 102 (information processing apparatus) to each other via a network 100.

The MFP 101 is a multi-function peripheral which is an image reading apparatus including not only a reading function, but also a printing function and a FAX function. However, the image reading apparatus is not limited to the MFP 101 insofar as it is an image reading apparatus that is restricted in combination of a variety of supported capabilities, and for example, the image reading apparatus can be a reading apparatus having the reading function and a communication function.

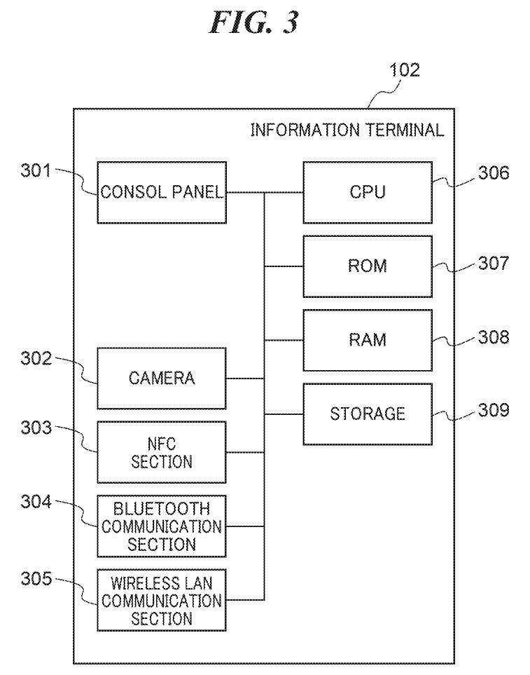

The information terminal 102 displays a UI screen related to the scan function on a screen of a console panel 301 (see FIG. 3), described hereinafter, generates a scan job in response to an operation performed by a user, not shown, sends a reading request to the MFP 101, and acquires image data.

Note that the network 100 in the present embodiment can be the Internet or a local area network (LAN). Further, the network 100 can be a wired network or a wireless network.

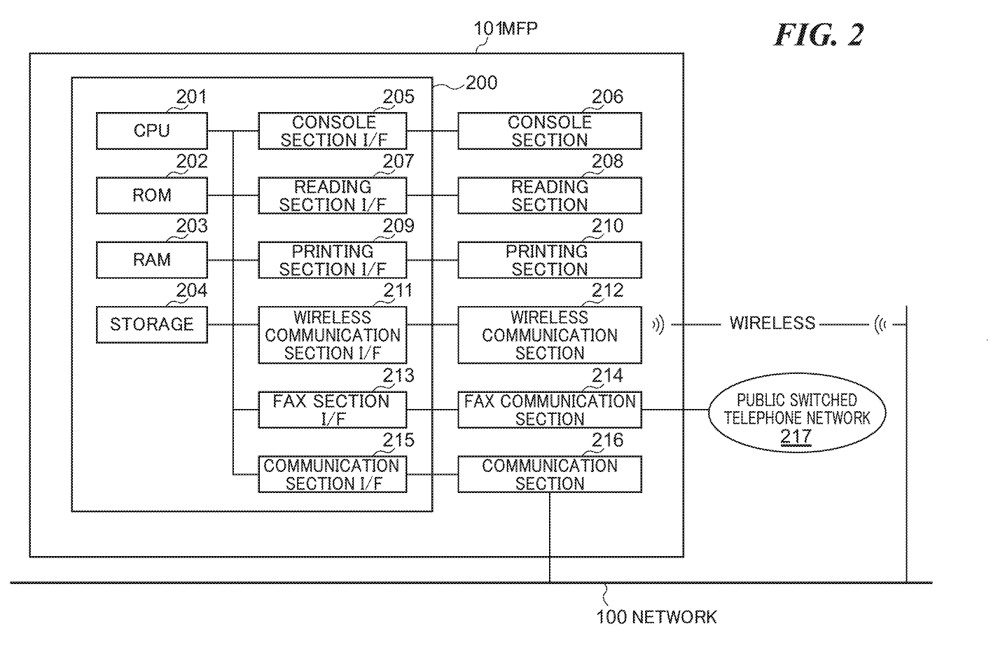

FIG. 2 is a block diagram showing an example of a hardware configuration of the MFP 101.

The MFP 101 includes a controller 200, a console section 206, a reading section 208, a printing section 210, a wireless communication section 212, a FAX communication section 214, and a communication section 216.

The controller 200 controls the overall operation of the MFP 101. Further, the controller 200 includes a central processing unit (CPU) 201, a read only memory (ROM) 202, a random access memory (RAM) 203, a storage 204, a console section interface (I/F) 205, a reading section I/F 207, a printing section I/F 209, a wireless communication section I/F 211, a FAX section I/F 213, and a communication section I/F 215.

The CPU 201 loads control programs stored in the ROM 202 or the storage 204 into the RAM 203 to perform a variety of controls, such as scan job analysis, reading control, and printing control.

The ROM 202 stores the control programs which can be executed by the CPU 201. Further, the ROM 202 also stores a boot program, font data, and so forth.

The RAM 203 is a main storage memory and is used as a work area and a temporary storage area for loading an OCR dictionary (not shown) for character recognition, a variety of UI setting items, and a variety of control programs stored in the ROM 202 and the storage 204.

The storage 204 stores an image file generated according to a scan job transmitted from the information terminal 102, the variety of programs, and a variety of setting information. Although in the present embodiment, a flash memory is assumed as the storage 204, an auxiliary storage device, such as a solid state drive (SSD) and a hard disk drive (HDD), can be used. Further, an embedded Multi Media Card (eMMC) can be used.

Note that although the MFP 101 in the present embodiment is configured such that the one CPU 201 executes processes indicated by flowcharts, described hereinafter, using one memory (RAM 203), this is not limitative. For example, the processes indicated by the flowcharts, described hereinafter, can be executed by operating a plurality of CPUs, RAMs, ROMs, and storages, in cooperation. Further, part of the processes can be executed by using a hardware circuit, such as an ASIC or an FPGA.

The console section I/F 205 connects between the console section 206 including a display section, such as a touch panel, and hard keys, and the controller 200. The console section 206 displays information to a user and detects an input from a user.

The reading section I/F 207 connects between the reading section 208, such as a scanner, and the controller 200. The reading section 208 reads an image from an original, and the CPU 201 converts the read image to image data, such as binary data. The image data generated based on the image read by the reading section 208 is converted to one of a variety of general image formats and then transmitted to an external apparatus, or printed on a recording sheet. Further, the reading section 208 has both of an original platen glass and an ADF. In a case where the original platen glass is used, the reading section 208 reads an image from an original placed on the original platen glass and generates image data. On the other hand, in a case where the ADF is used, the reading section 208 conveys an original placed on an ADF original tray to the ADF, reads an image from the conveyed original, and generates image data.

The printing section I/F 209 connects between the printing section 210, such as a printer, and the controller 200. The CPU 201 transfers image data (print data) stored in the RAM 203 to the printing section 210 via the printing section I/F 209. The printing section 210 prints an image based on the transferred image data on a recording sheet fed from a sheet feed cassette.

The wireless communication I/F 211 is an I/F for controlling the wireless communication section 212, and with this, the controller 200 can connect to an external wireless device via wireless connection. The controller 200 can perform connection to a public switched telephone network 217, control of a facsimile communication protocol, and so forth, by controlling the FAX communication section 214 via the FAX section I/F 213.

The communication section I/F 215 is an I/F for controlling the communication section 216, and, with this, the controller 200 can connect the network 100. The controller 200 can perform transmission of image data and a variety of information in the apparatus to an external apparatus on the network 100, reception of print data and information on the network 100 from an external device on the network 100, and so forth, via the communication section I/F 215 and the communication section 216. As the method of transmission/reception via the network 100, transmission/reception using an E-mail and file transmission using one of other protocols (such as the file transfer protocol (FTP), the server message block (SMB), and the web distributed authoring and versioning (WEBDAV)) can be performed. Further, a capabilities request, a scan job, and a variety of setting data can be transmitted and received via the network 100 by accessing from the information terminal 102 by hypertext transfer protocol (HTTP) communication.

FIG. 3 is a block diagram showing an example of a hardware configuration of the information terminal 102. Note that although as the information terminal 102 of the present embodiment, an apparatus, such as a smartphone, a tablet, and a PC, is assumed, any other apparatus can be used insofar as it is an information processing apparatus that is capable of communicating with the MFP 101.

The information terminal 102 includes the console panel 301, a camera 302, a near field communication (NFC) section 303, a Bluetooth (registered trademark) communication section 304, a wireless LAN communication section 305, a CPU 306, a ROM 307, a RAM 308, and a storage 309.

The CPU 306 reads out control programs stored in the ROM 307 and executes a variety of processes for controlling the operation of the information terminal 102.

The ROM 307 stores the control programs of the information terminal 102.

The RAM 308 is used as a main memory for the CPU 306 and a temporary storage area, such as a work area.

The storage 309 stores a variety of data, such as photographs and electronic documents.

The console panel 301 has a touch panel function which can detect a user’s touch operation and displays a variety of screens provided by an OS and an E-mail transmission application. The user can input a desired operation instruction to the information terminal 102 by inputting a touch operation on the console panel 301. The information terminal 102 can be provided with hardware keys, not shown, and the user can input an operation instruction to the information terminal 102 by using the hardware keys.

The camera 302 performs image capturing according to a user’s instruction. A photograph taken by the camera 302 is stored in a predetermined area of the storage 309. Further, by using a program which is capable of analyzing a QR code (registered trademark), it is also possible to acquire information from the QR code read by the camera 302.

The information terminal 102 is capable of transmitting and receiving data to and from a variety of peripheral devices via the NFC section 303, the Bluetooth communication section 304, and the wireless LAN communication section 305. The Bluetooth communication section 304 of the information terminal 102 can support Bluetooth Low Energy.

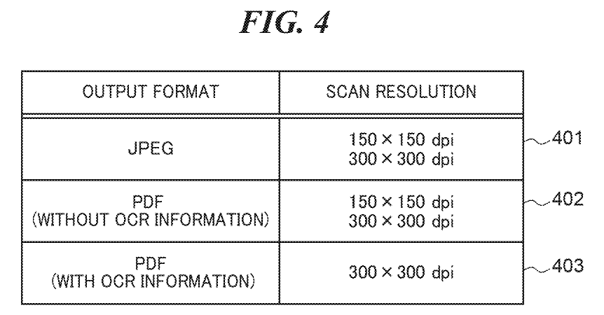

FIG. 4 is a diagram showing a relationship between output formats and scan resolutions (reading settings), supported by the MFP 101 in a scan job.

As indicated in a row 401 in FIG. 4, in the MFP 101, in a case where the output format in a scan job is JPEG, the resolution can be set to one of 150 × 150 dpi and 300 × 300 dpi. Further, as indicated in a row 402 in FIG. 4, in a case where the output format is PDF (without OCR information) (first output format) as well, the resolution can be set to one of 150 × 150 dpi and 300 × 300 dpi. On the other hand, as indicated in a row 403, in a case where the output format is PDF (with OCR information) (second output format), the resolution can be set only to 300 × 300 dpi. Here, PDF (with OCR information) is a derivative format of PDF (without OCR information) and is an output format which is more restricted in scan resolution than PDF (without OCR information).

Here, in the present embodiment, the relationship between the output formats and the scan resolutions, shown in FIG. 4, is statically held (managed) in the ROM 202 (management unit) e.g. in a table data format and is loaded into the RAM 203 by the CPU 201 when the MFP 101 is started. This enables the CPU 201 to refer to the relationship between the output formats and the scan resolutions, shown in FIG. 4, as required.

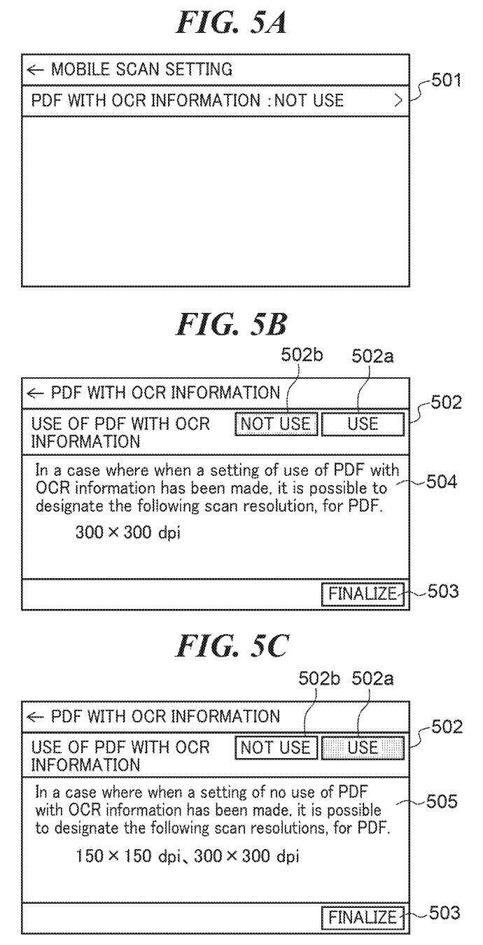

FIGS. 5A to 5C are diagrams each showing an example of a screen displayed on the MFP 101, for setting whether or not to use PDF with OCR information when mobile scan is performed.

The CPU 201 of the MFP 101 receives a setting change of a setting item 501 for setting whether or not to use PDF with OCR information when mobile scan is performed on a screen shown in FIG. 5A via the console section 206. When the user presses the setting item 501 on the screen shown in FIG. 5A, a screen shown in FIG. 5B is displayed.

FIG. 5B shows a screen for setting PDF with OCR information, which is displayed when the setting item 501 appearing in FIG. 5A is pressed by the user.

As shown in FIG. 5B, the screen for setting PDF with OCR information includes a setting display section 502, a finalize button 503, and a message 504.

The setting display section 502 (setting receiving unit) displays a setting of whether or not to use PDF with OCR information (permission/non-permission) in a state changeable by a user.

When the finalize button 503 is pressed by the user, the setting displayed on the setting display section 502 is stored in the RAM 203 and the storage 204. On the screen shown in FIG. 5B, a “use” button 502a indicating that the use of PDF with OCR information is permitted when mobile scan is performed has been selected by the user. When a “not use” button 502b indicating that the use of PDF with OCR information is not permitted is pressed by the user in this state, the display is switched to a screen shown in FIG. 5C.

The message 504 is a message displayed in a case where the “use” button 502a is selected by the user. In a case where the setting of “use” currently selected by the user is finalized, the message 504 notifies the user that 150 × 150 dpi cannot be designated as the scan resolution but only 300 × 300 dpi can be designated.

FIG. 5C shows a screen for setting PDF with OCR information, which is displayed when the “not use” button 502b appearing in FIG. 5B is pressed by the user.

As shown in FIG. 5C, the screen for setting PDF with OCR information includes the setting display section 502, the finalize button 503, and a message 505.

On the screen shown in FIG. 5C, the “not use” button 502b indicating that the use of PDF with OCR information is not permitted when mobile scan is performed has been selected by the user. When the “use” button 502a indicating that the use of PDF with OCR information is permitted is pressed by the user in this state, the display is switched to the screen shown in FIG. 5B.

The message 505 is a message displayed in a case where the “not use” button 502b is selected by the user. In a case where the setting of “not use” currently selected by the user is finalized, the message 505 notifies the user that the two resolutions of 150 × 150 dpi and 300 × 300 dpi can be designated.

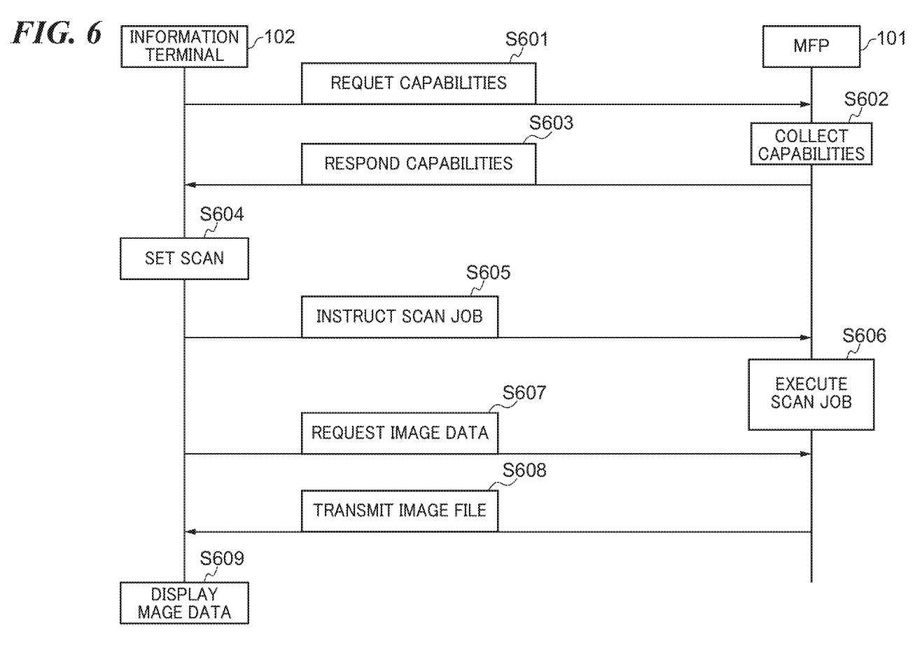

FIG. 6 is a sequence diagram of a process related to a scan job, which is performed by the information terminal 102 and the MFP 101.

In the information terminal 102, part of the present process is executed by the CPU 306 that reads out a control program stored in the ROM 307, loads the control program into the RAM 308, and executes the loaded program. Further, in the MFP 101, the remaining part of the present process is executed by the CPU 201 that reads out a control program stored in the ROM 202 or the storage 204, loads the control program into the RAM 203, and executes the loaded program.

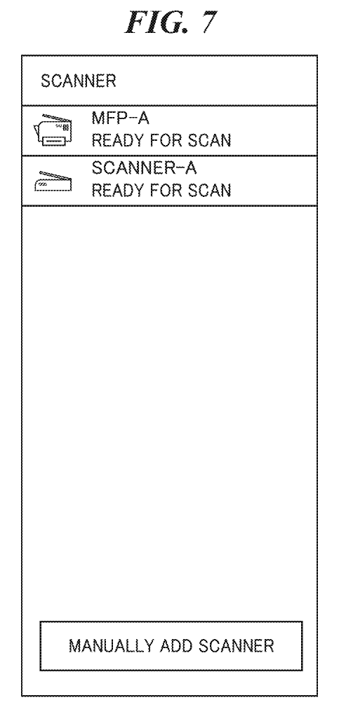

When the scan function is selected by the user, the CPU 306 of the information terminal 102 displays a scanner selection screen, shown in FIG. 7, on the console panel 301. Note that the present sequence is started in a case where the MFP 101 is registered as a new scanner, or when the MFP 101 which has already been registered is enabled to communicate with the information terminal 102 via the network.

When the present sequence is started, first, in a step S601, the CPU 306 (capabilities information acquisition unit/requesting unit) of the information terminal 102 transmits a capabilities request to the MFP 101. The capabilities request in this step is transmitted by HTTP communication including a character string, such as “GET ScannerCapabilities”.

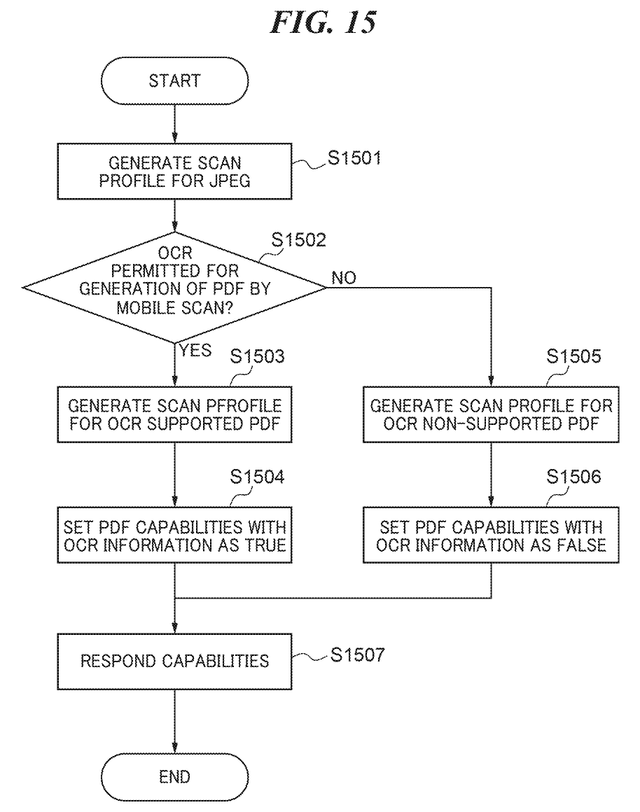

Upon receipt of the capabilities request transmitted from the information terminal 102 in the step S601, the CPU 201 of the MFP 101 stores contents of this request in the RAM 203 and then proceeds to a step S602. In the step S602, the CPU 201 collects the capabilities information to be transmitted to the information terminal 102 as a response (capabilities collection). Note that details of the processing in the step S602 will be described hereinafter with reference to FIG. 15.

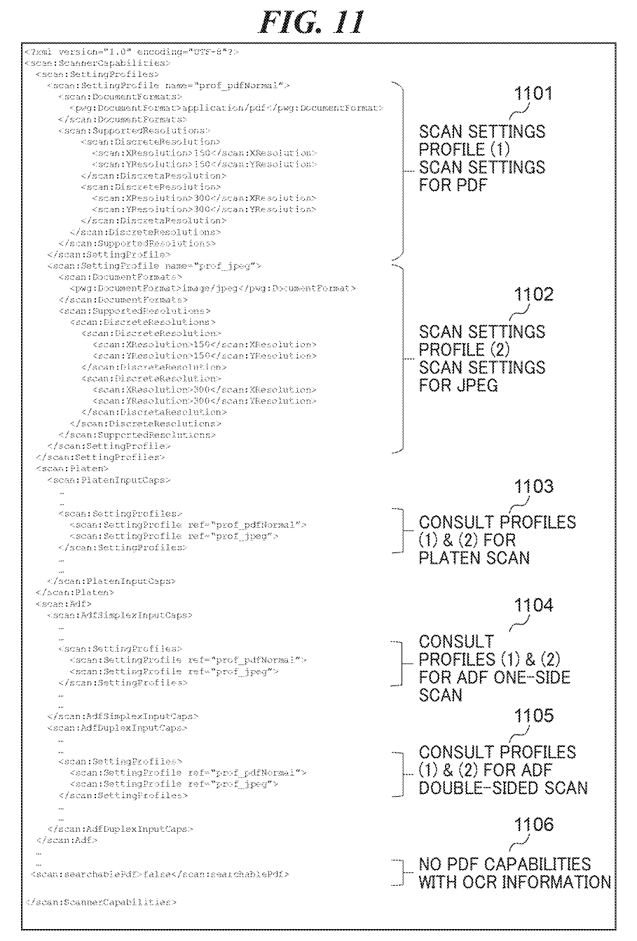

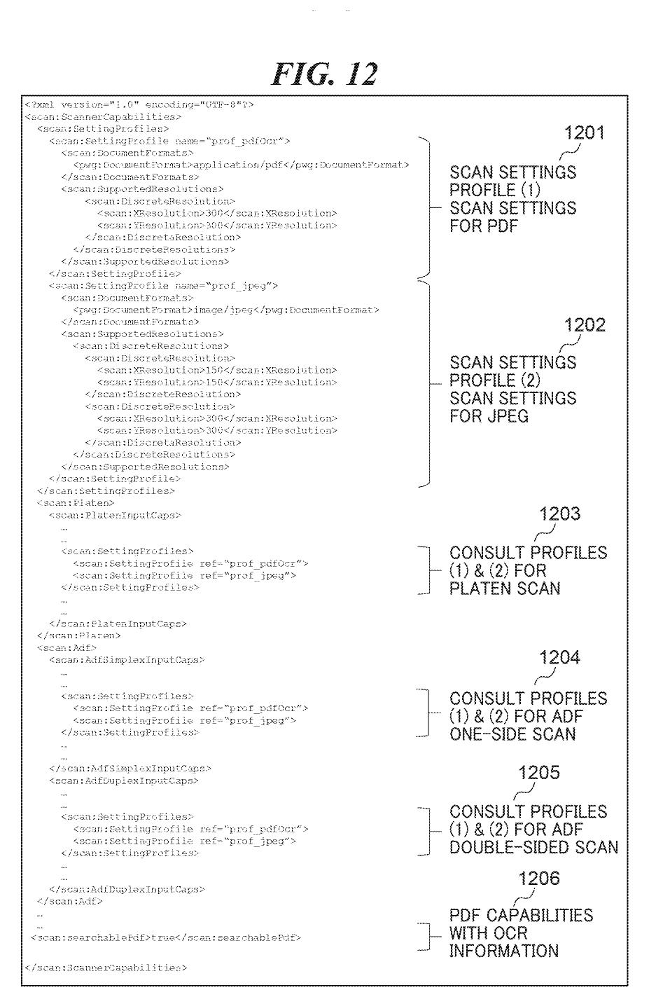

Next, in a step S603, the CPU 201 (transmission unit) of the MFP 101 transmits the capabilities information collected in the step S602 to the information terminal 102 as a response to perform the capabilities response. FIGS. 11 and 12 each show an example of the capabilities information transmitted from the MFP 101 to the information terminal 102 as the response in the step S603 in the present embodiment.

FIG. 11 is a diagram showing an example of the capabilities information (first capabilities information) transmitted from the MFP 101 to the information terminal 102 as a response in a case where the use of PDF with OCR information at the time of mobile scan is not permitted by the user on the screen shown in FIG. 5C.

The capabilities information shown in FIG. 11 includes a first scan profile 1101, a second scan profile 1102, platen scan capabilities 1103, ADF one-side scan capabilities 1104, ADF both-side scan capabilities 1105, and PDF capabilities with OCR information 1106.

The first scan profile 1101 (first reading profile) is a profile that in a case where the output format is PDF, 150 × 150 dpi and 300 × 300 dpi are supported as the scan resolutions. In FIG. 11, the first scan profile 1101 is denoted as prof_pdfNormal.

The second scan profile 1102 is a profile (prof_jpeg) that in a case where the output format is JPEG, 150 × 150 dpi and 300 × 300 dpi are supported as the scan resolutions.

The platen scan capabilities 1103 describe that when an original is scanned by using the platen (original platen glass), the scan profiles of the first scan profile 1101 and the second scan profile 1102 can be used.

The ADF one-side scan capabilities 1104 describe that when one-side scan using the ADF is performed on an original, the scan profiles of the first scan profile 1101 and the second scan profile 1102 can be used.

The ADF both-side scan capabilities 1105 describe that when both-side scan using the ADF is performed on an original, the scan profiles of the first scan profile 1101 and the second scan profile 1102 can be used.

The PDF capabilities with OCR information 1106 describe that PDF capabilities with OCR information (searchable Pdf) are not included (false).

FIG. 12 is a diagram showing an example of the capabilities information (second capabilities information) transmitted from the MFP 101 to the information terminal 102 as a response in a case where the use of PDF with OCR information at the time of mobile scan is permitted by the user on the above-described screen shown in FIG. 5B.

The capabilities information shown in FIG. 12 includes a first scan profile 1201, a second scan profile 1202, platen scan capabilities 1203, ADF one-side scan capabilities 1204, ADF both-side scan capabilities 1205, and PDF capabilities with OCR information 1206.

The first scan profile 1201 (second reading profile) is a profile (prof_pdfOcr) that in a case where the output format is PDF, only 300 × 300 dpi is supported as the scan resolution.

The second scan profile 1202 is a profile (prof_jpeg) that in a case where the output format is JPEG, 150 × 150 dpi and 300 × 300 dpi are supported as the scan resolutions.

The platen scan capabilities 1203 describes that when an original is scanned by using the platen (original platen glass), the scan profiles of prof_pdfOcr and prof_jpeg can be used.

The ADF one-side scan capabilities 1204 describes that when one-side scan using the ADF is performed on an original, the scan profiles of prof_pdfOcr and prof_jpeg can be used.

The ADF both-side scan capabilities 1205 describes that when both-side scan using the ADF is performed on an original, the scan profiles of prof_pdfOcr and prof_jpeg can be used.

The PDF capabilities with OCR information 1206 describes that the PDF capabilities with OCR information (searchable Pdf) are included (true).

Referring again to FIG. 6, upon receipt of the capabilities information transmitted from the MFP 101 in the step S603, the CPU 306 of the information terminal 102 stores the received capabilities information in the work area of the RAM 308 and proceeds to a step S604 to start the scan setting. Here, a case where the above-described capabilities information shown in FIG. 11 is received as the capabilities information, i.e., a case where the use of PDF with OCR information at the time of mobile scan is not permitted by the user will be described.

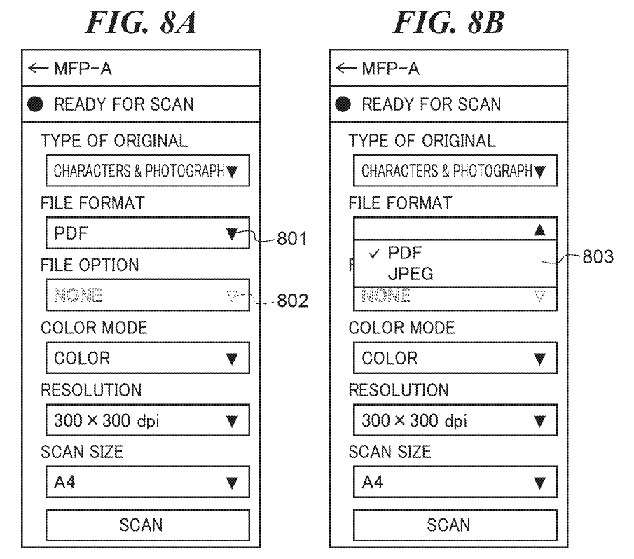

In the step S604, first, the CPU 306 displays the scanner selection screen shown in FIG. 7 and waits for the user to select a scanner to be used for mobile scan by busing this screen. Here, a case where the MFP 101 (described as MFP-A in FIG. 7) is selected by the user on the scanner selection screen shown in FIG. 7 will be described. Next, when a scanner is selected by the user, the display on the console panel 301 is changed to a scan setting screen shown in FIG. 8A.

Next, the CPU 306 of the information terminal 102 receives scan parameter settings designated by the user on the scan setting screen (receiving unit).

FIGS. 8A and 8B are diagrams each showing an example of the scan setting screen displayed on the console panel 301 of the information terminal 102 in a case where it is recognized that the PDF capabilities with OCR information at the time of mobile scan are not included.

For example, when the user presses a file format menu 801 on the scan setting screen shown in FIG. 8A, the CPU 306 of the information terminal 102 displays a drop-down menu 803 appearing in FIG. 8B to receive selection of a file format from the user. On the drop-down menu 803 appearing in FIG. 8B, the user can select one of PDF and JPEG as the file format. Further, here, the capabilities information transmitted from the MFP 101 as the capabilities response in the step S603 is the capabilities information shown in FIG. 11, and it is recognized that the PDF capabilities with OCR information at the time of mobile scan are not included (searchable PDF is false). Therefore, an operation on a file option menu 802 appearing in FIG. 8A is disabled (grayed out), and the file option is fixed to “none” and cannot be set to OCR (character recognition).

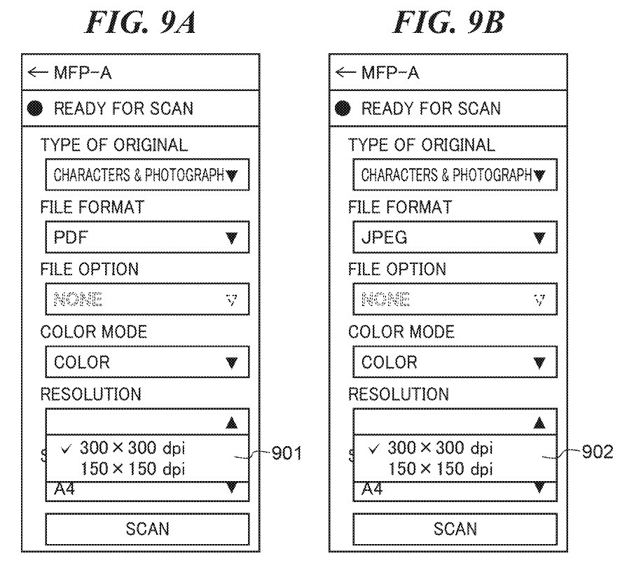

FIGS. 9A and 9B are diagrams each showing an example of scan resolutions which can be set for each file format, for being displayed on the scan setting screen shown in FIGS. 8A and 8B.

The scan setting screen shown in FIG. 9A shows the scan resolutions which can be set in a case where the file format is PDF. The user can set (designate) one of 150 × 150 dpi and 300 × 300 dpi from a drop-down menu 901 appearing in FIG. 9A.

The scan setting screen shown in FIG. 9B shows the scan resolutions which can be set in a case where the file format is JPEG. The user can set one of 150 × 150 dpi and 300 × 300 dpi from a drop-down menu 902 appearing in FIG. 9B.

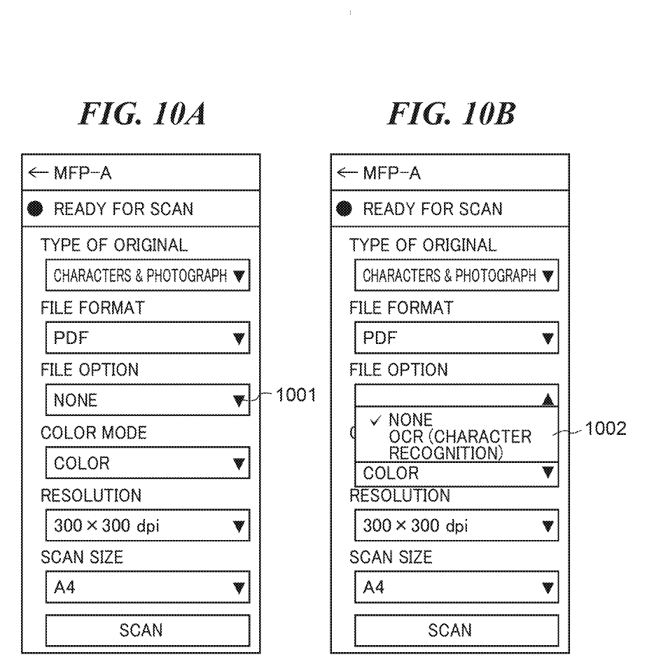

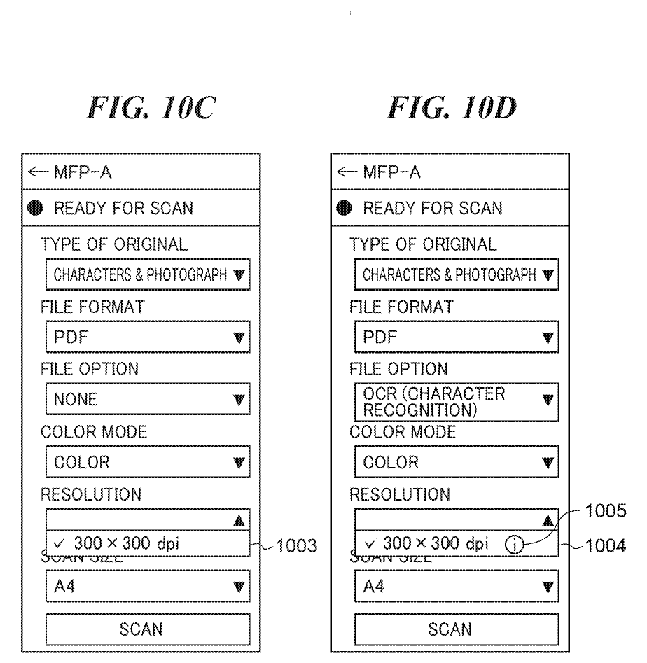

FIG. 10A to 10D are diagrams each showing an example of the scan setting screen displayed on the console panel 301 of the information terminal 102 in a case where it is recognized that the PDF capabilities with OCR information at the time of mobile scan are included.

Here, the capabilities information transmitted from the MFP 101 as the capabilities response in the step S603 is the capabilities information shown in FIG. 12, and it is recognized that the PDF capabilities with OCR information at the time of mobile scan are included (searchable PDF is true). Therefore, when the user presses a file option menu 1001 on a scan resolution selection screen shown in FIG. 10A, the CPU 306 of the information terminal 102 displays a drop-down menu 1002 shown in FIG. 10B. With this, selection of the file option menu is received from the user. In FIG. 10B, PDF is selected as the file format, and hence the user can select one of “none” and “OCR (character recognition)” on the dropdown menu 1002 as the file option.

Thus, differently from the scan setting screen shown in FIG. 8A, the operation on the file option menu 1001 is enabled. Therefore, by pressing the file option menu 1001, the user can select and set whether or not to use the OCR option on the drop-down menu 1002 appearing in FIG. 10B.

When PDF is selected as the file format, and at the same time “none” is selected as the file option on the scan setting screen shown in FIG. 10A, only the scan resolution of 300 × 300 dpi becomes selectable on a drop-down menu 1003 as shown in FIG. 10C.

Note that the capabilities information shown in FIG. 12 can include the first scan profile 1101. In this case, in a case where “none” is set to the file option in FIG. 10C, not only the scan resolution of 300 × 300 dpi, but also the scan resolution of 150 × 150 dpi becomes selectable by the user.

When PDF is selected as the file format and at the same time OCR (character recognition) is selected as the file option on the scan setting screen shown in FIG. 10A, only the scan resolution of 300 × 300 dpi becomes selectable on a drop-down menu 1004 as shown in FIG. 10D.

Further, when an information button 1005 displayed beside the display of “300 × 300 dpi” on the drop-down menu 1004 is pressed, a warning popup is displayed. For example, a message “You can designate the scan resolution only to 300 × 300 dpi. In a case where the file format is JPEG, you can set the scan resolution to 150 × 150 dpi.” is displayed on the warning popup. With this message, the user understands that if the user desires to execute mobile scan at a scan resolution other than 300 × 300 dpi, it is only required to change the file format.

Thus, when the scan button is pressed after the scan setting is received from the user on the scan setting screen in the step S604, the CPU 306 of the information terminal 102 generates a scan job instruction using the received scan setting. Then, the process proceeds to a step S605, and the CPU 306 (instruction transmission unit) of the information terminal 102 transmits the generated scan job instruction to the MFP 101. The scan job instruction in this step is transmitted by HTTP communication including a character string, such as “POST ScanJob”.

Upon receipt of the scan job instruction transmitted from the information terminal 102 in the step S605, the CPU 201 (reception unit) of the MFP 101 proceeds to a step S606. In the step S606, the CPU 201 of the MFP 101 reads an original image using the reading section 208 (image reading unit) and stores the read image in the RAM 203 as image data. The CPU 201 of the MFP 101 generates an image file of a file format designated by the received scan job instruction, by executing a format conversion program stored in the ROM 202 or the storage 204 on the image data stored in the RAM 203. In the present embodiment, a PDF or JPEG image file is generated. Here, there is a case where the file format designated by the received scan job instruction is PDF, and the OCR (character recognition) option is designated. In this case, first, the CPU 201 performs OCR processing on the generated image file by using an OCR processing program stored in the ROM 202 or the storage 204. Next, the CPU 201 generates PDF with OCR information to which the OCR information obtained by this OCR processing has been added. The image file generated by the CPU 201 can be stored in the RAM 203 or stored in the storage 204.

After transmitting the scan job instruction to the MFP 101 in the step S605, the CPU 306 (image acquisition unit) of the information terminal 102 proceeds to a step S607 to transmit an image data request (image request) to the MFP 101. The image data acquisition request in the step S607 is transmitted by HTTP communication including a character string, such as “GET Document”.

Upon receipt of the image data request transmitted from the information terminal 102 in the step S607, the CPU 201 of the MFP 101 waits until the image file generated in the step S606 is stored in the RAM 203 or the storage 204. After that, when the image file has been stored in the RAM 203 or the storage 204, the CPU 201 proceeds to a step S608.

In the step S608, the CPU 201 of the MFP 101 transmits the image file stored in the RAM 203 or the storage 204 to the information terminal 102.

Upon receipt of the image file transmitted from the MFP 101 in the step S608, the CPU 306 of the information terminal 102 displays the image data included in the received image file on the console panel 301 in a step S609. Then, the series of processing operations shown in FIG. 6 is terminated.

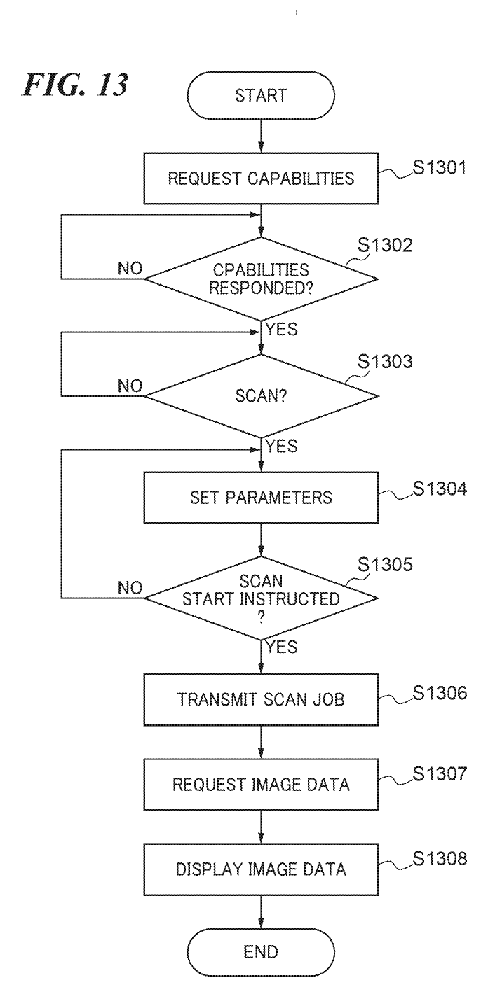

FIG. 13 is a flowchart of a process related to the scan job, which is performed by the information terminal 102. The present process is executed by the CPU 306 of the information terminal 102, which reads out a control program stored in the ROM 307, loads the control program into the RAM 308, and executes the loaded control program.

In a step S1301, the CPU 306 of the information terminal 102 transmits a capabilities request to the MFP 101. The step S1301 is the same as the above-described step S601 in FIG. 6, and hence detailed description is omitted.

In a step S1302, the CPU 306 of the information terminal 102 waits for reception of a capabilities response (the step S603 in FIG. 6) which transmits the capabilities information from the MFP 101 in response to the response request, and when the capabilities response is received, the CPU 306 proceeds to a step S1303.

In the step S1303, the CPU 306 of the information terminal 102 displays the scanner selection screen shown in FIG. 7 on the console panel 301 and waits for the user to select a scanner to be used for mobile scan by using this screen. When a scanner is selected by the user, the process proceeds to a step S1304. In the step S1304, the CPU 306 of the information terminal 102 receives an input from the user on the scan setting screen (FIGS. 8A to 10D) switched according to the capabilities information of the MFP 101, which has been received in the step S1302, and a user’s input, thereby making scan parameter settings. The steps S1303 and S1304 are the same processing operations as the above-described processing for receiving the scan setting from the user in the step S604 in FIG. 6, and hence detailed description is omitted.

In a step S1305, the CPU 306 of the information terminal 102 determines whether or not a scan start instruction has been given by the user, i.e., whether or not the scan button has been pressed on one of the scan setting screens shown in FIGS. 8A to 10D. If the scan button has not been pressed (NO to the step S1305), the process returns to the step S1304. On the other hand, if the scan button has been pressed (YES to the step S1305), the CPU 306 of the information terminal 102 generates a scan job instruction using the scan settings received in the steps S1303 and S1304 and then proceeds to a step S1306.

In the step S1306, the CPU 306 of the information terminal 102 transmits the scan job instruction to the MFP 101. The step S1306 is the same as the step S605 in FIG. 6, and hence detailed description is omitted.

In the following step S1307, the CPU 306 of the information terminal 102 transmits an image data request to the MFP 101. The step S1307 is the same as the step S607 in FIG. 6, and hence detailed description is omitted.

In the following step S1308, upon receipt of the image file from the MFP 101 in response to the image data request (the step S608 in FIG. 6), the CPU 306 of the information terminal 102 displays the image data included in the received image file on the console panel 301, followed by terminating the present process.

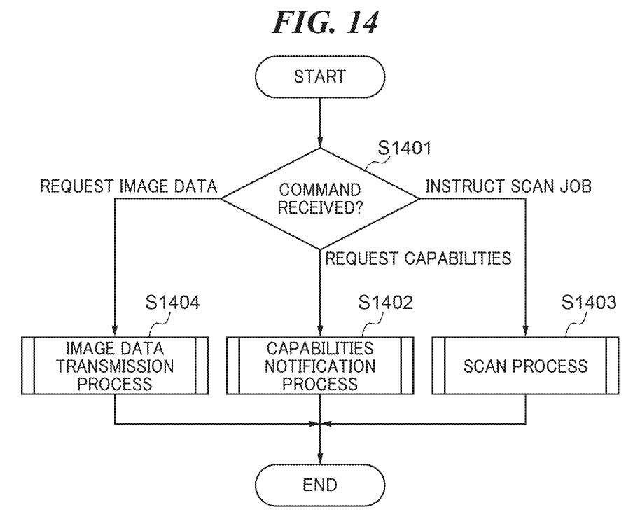

FIG. 14 is a flowchart of a process related to the scan job, which is performed by the MFP 101. The present process is executed by the CPU 201 that reads out a control program stored in the ROM 202 or the storage 204, loads the control program into the RAM 203, and executes the loaded control program.

In a step S1401, the CPU 201 of the MFP 101 waits for reception of a command from the information terminal 102.

As a result of waiting for reception of a command in the step S1401, if the received command is a capabilities request (the step S601 in FIG. 6), the CPU 201 of the MFP 101 proceeds to a step S1402 to execute a capabilities notification process, followed by terminating the present process. Details of the capabilities notification process executed in the step S1402 will be described hereinafter with reference to FIG. 15.

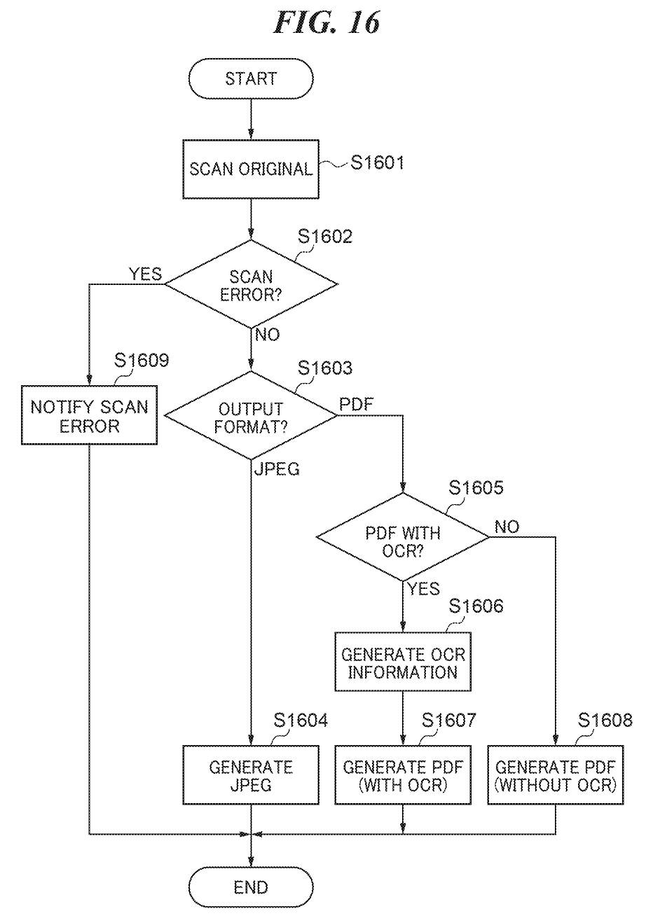

As a result of waiting for reception of a command in the step S1401, if the received command is a scan job instruction (the step S605 in FIG. 6), the CPU 201 of the MFP 101 proceeds to a step S1403 to execute a scan process, followed by terminating the present process. Details of the scan process executed in the step S1403 will be described hereinafter with reference to FIG. 16.

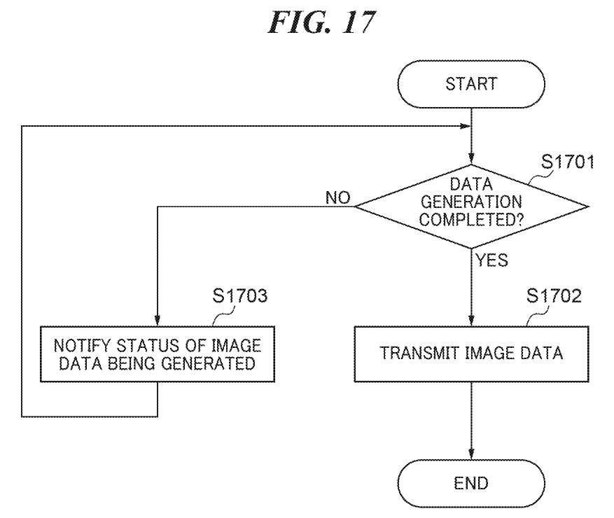

As a result of waiting for reception of a command in the step S1401, if the received command is an image data request (the step S607 in FIG. 6), the CPU 201 of the MFP 101 proceeds to a step S1404 to execute an image data transmission process, followed by terminating the present process. Details of the image data transmission process executed in the step S1404 will be described hereinafter with reference to FIG. 17.

FIG. 15 is a flowchart of the capabilities notification process performed in the step S1402 in FIG. 14.

In a step S1501, the CPU 201 of the MFP 101 refers to the above-described table indicating the relationship between the output formats and the scan resolutions, described with reference to FIG. 4, and generates a scan profile in a case where the output format is JPEG.

In a step S1502, the CPU 201 of the MFP 101 checks, based on the settings described with reference to FIGS. 5A to 5C, whether or not the use of PDF with OCR information is permitted when mobile scan is performed. If the use of PDF with OCR information is permitted (YES to the step S1502), the CPU 201 proceeds to a step S1503, whereas if the use of PDF with OCR information is not permitted (NO to the step S1502), the CPU 201 proceeds to a step S1505.

In the step S1503, the CPU 201 of the MFP 101 generates a scan profile for OCR-supported PDF, which is formed by scan resolutions commonly supported by normal PDF and PDF with OCR information. Next, in a step S1504, the CPU 201 of the MFP 101 sets the PDF capabilities with OCR information as true. Then, the CPU 201 proceeds to a step S1507.

In the step S1505, the CPU 201 of the MFP 101 generates a scan profile for OCR-non-supported PDF, which is formed by scan resolutions supported only by normal PDF. In a step S1506, the CPU 201 of the MFP 101 sets the PDF capabilities with OCR information as false. Then, the CPU 201 proceeds to the step S1507.

In the step S1507, the CPU 201 of the MFP 101 transmits the capabilities response to transmit the capabilities information collected in the steps S1501 to S1506 to the information terminal 102, followed by terminating the present process.

FIG. 16 is a flowchart showing the scan process performed in the step S1403 in FIG. 14.

In a step S1601, the CPU 201 of the MFP 101 controls the reading section 208 to scan the original. The original to be scanned in this step has been placed on the original platen glass or the ADF original tray of the reading section 208 by the user in advance. When the reading section 208 detects that the original has been placed on the ADF original tray, by using an original detection sensor, not shown, disposed on the ADF original tray, the CPU 201 controls the reading section 208 to convey the original placed on the ADF original tray to the ADF and execute scan. On the other hand, in a case where it is not detected by the original detection sensor that the original has been placed on the ADF original tray, the CPU 201 determines that the original has been placed on the original platen glass and controls the reading section 208 to execute scan of the original placed on the original platen glass.

In a step S1602, the CPU 201 of the MFP 101 confirms whether or not an error associated with scan of the original (scan error) has occurred.

If a scan error has occurred (YES to the step S1602), the CPU 201 of the MFP 101 proceeds to a step S1609 to notify the information terminal 102 that a scan error has occurred, followed by terminating the series of the scan process. In this case, a scan error notification screen is displayed on the console panel 301 of the information terminal 102. Note that the scan error notification screen can also be displayed on the display section of the console section 206 of the MFP 101.

On the other hand, if a scan error has not occurred (NO to the step S1602), the CPU 201 of the MFP 101 proceeds to a step S1603 to confirm the output format.

If the output format is JPEG, the CPU 201 of the MFP 101 proceeds to a step S1604 to generate a JPEG image file from the scanned image data and store the generated image file in the RAM 203 or the storage 204, followed by terminating the present process.

If the output format is PDF, the CPU 201 of the MFP 101 proceeds to a step S1605 to check whether or not the OCR option has been set in the scan setting of the job.

If the OCR option has been set (YES to the step S1605), the CPU 201 of the MFP 101 proceeds to a step S1606 to execute the OCR processing on the scanned image and proceeds to a step S1607.

In the step S1607, the CPU 201 (second image generation unit) of the MFP 101 generates PDF with OCR information (second image) and stores the generated PDF as the scanned image data (transmission image) which can be transmitted to the RAM 203 or the storage 204, followed by terminating the present process.

On the other hand, if the OCR option has not been set (NO to the step S1605), the CPU 201 of the MFP 101 proceeds to a step S1608.

In the step S1608, the CPU 201 (first image generation unit) of the MFP 101 generates normal PDF (PDF without OCR information: first image) and stores the generated PDF as the scanned image data (transmission image) which can be transmitted to the RAM 203 or the storage 204, followed by terminating the present process.

FIG. 17 is a flowchart of the image data transmission process performed in the step S1404 in FIG. 14.

In a step S1701, the CPU 201 of the MFP 101 confirms whether or not the generation of the scanned image data which can be transmitted has been completed by the scan process in the step S1403.

If the generation of the scanned image data has been completed (YES to the step S1701), the CPU 201 of the MFP 101 proceeds to a step S1702 to transmit the generated scanned image data to the information terminal 102, followed by terminating the present process.

On the other hand, if the generation of the scanned image data has not been completed (NO to the step S1701), the CPU 201 of the MFP 101 proceeds to a step S1703 to notify the information terminal 102 of the status of image data being generated and returns to the step S1701.

As described above, in the present embodiment, the MFP 101 supports 150 × 150 dpi and 300 × 300 dpi as the scan resolutions of PDF. However, the description has been given of the example that in a case where the use of PDF with OCR information at the time of mobile scan is permitted, the capabilities information including only 300 × 300 dpi as the scan resolution in a case where the output format is PDF is notified from the MFP 101 to the information terminal 102. However, the combination of the output format and the scan resolution is not limited to this, and the MFP 101 can be configured to also support another scan resolution as the scan resolution of PDF. However, in this case, as the scan resolution in the case where the output format is PDF, out of the scan resolutions of PDF, which are supported by the MFP 101, only a scan resolution which can be used for PDF with OCR information is included in the capabilities information.

For example, the MFP 101 can support 100 × 100 dpi, 150 × 150 dpi, 200 × 200 dpi, 300 × 300 dpi, 400 × 400 dpi, and 600 × 600 dpi as the scan resolutions of PDF. In this case, as the scan resolutions in the case where the output format is PDF, only 200 × 200 dpi, 300 × 300 dpi, 400 × 400 dpi, and 600 × 600 dpi are included in the above-described capabilities information.

Further, the MFP 101 can support 200 × 200 dpi, 300 × 300 dpi, 400 × 400 dpi, and 600 × 600 dpi as the scan resolutions of PDF. In this case, as the scan resolutions in the case where the output format is PDF, only 200 × 200 dpi and 300 × 300 dpi are included in the above-described capabilities information.

Further, the MFP 101 can support 75 × 75 dpi, 150 × 150 dpi, 200 × 200 dpi, 300 × 300 dpi, 400 × 400 dpi, and 600 × 600 dpi as the scan resolutions of PDF. In this case, as the scan resolutions in the case where the output format is PDF, only 75 × 75 dpi, 150 × 150 dpi, 200 × 200 dpi, and 300 × 300 dpi are included in the above-described capabilities information.

Although in the present embodiment, the description has been given of the case where the service is provided from the MFP 101 restricted in the scan resolution which can be set, depending on an output format and a scan option, to the information terminal, this is not limitative, insofar as the configuration is such that the service is provided from a device which is restricted in combination of a variety of supported capabilities to the information terminal.

As described above, according to the present disclosure, even when a device which is restricted in combination of a variety of supported capabilities is used, it is possible to notify an information terminal of the capabilities from the device without contradicting the restriction of the combination. Further, it is possible to change, on the device side, the setting of permission of application of the capabilities (the scan option in the present embodiment) supported, and notify the information terminal of the capabilities information from the device according to the application state.

The present disclosure is not limited to the above-described embodiment, but it is to be understood that the disclosure includes various forms within the scope of the gist of the present disclosure. Therefore, the claims are appended to publish the scope of the disclosure.

According to the present disclosure, even when an image reading apparatus which is restricted in combination of a variety of supported capabilities is used, it is possible to notify an information processing apparatus of the variety of supported capabilities from the image reading apparatus without contradicting the restriction of the combination.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-053179, filed March 27, 2025, which is hereby incorporated by reference herein in its entirety.

What is claimed is:

1. An image reading apparatus communicably connected to an information processing apparatus, including:
at least one processor; and
a memory storing instructions that, when executed by the at least one processor, causes the at least one processor to function as:
a transmission unit configured to transmit capabilities information of the image reading apparatus including a plurality of reading settings, to the information processing apparatus;
a reception unit configured to receive an instruction including a reading setting designated by a user according to the capabilities information transmitted by the transmission unit, from the information processing apparatus;
an image reading unit configured to execute reading of an image according to the instruction received by the reception unit;
a first image generation unit configured to generate a first image converted in a first output format from the read image;
a second image generation unit configured to generate a second image converted in a second output format which is a derivative format of the first output format and is more restricted in reading settings than the first output format, from the read image; and
a setting receiving unit configured to receive from a user a setting of permission or no permission of use of the second output format with respect to reading of an image executed according to the instruction received by the reception unit,
wherein the transmission unit
transmits, in a case where the setting received by the setting receiving unit is a setting of no permission of the use of the second output format, first capabilities information including a first reading profile formed by reading settings usable in the first output format, to the information processing apparatus, as the capabilities information,
transmits, in a case where the setting received by the setting receiving unit is a setting of permission of the use of the second output format, second capabilities information including a second reading profile formed by reading settings usable in the second output format, to the information processing apparatus, as the capabilities information,
generates, in a case where the first output format is set in the instruction received by the reception unit, the first image by the first image generation unit, as a transmission image, and
generates, in a case where the second output format is set in the instruction received by the reception unit, the second image by the second image generation unit, as the transmission image.

2. The image reading apparatus according to claim 1, wherein the first output format is PDF, and the second output format is PDF with OCR information.

3. The image reading apparatus according to claim 1, wherein the first reading profile and the second reading profile each include at least information of a resolution in the reading of an image, which is to be executed by the image reading unit.

4. The image reading apparatus according to claim 1, wherein the transmission unit transmits the transmission image to the information processing apparatus, in a case where, after the instruction is received, an image acquisition request is received from the information processing apparatus.

5. The image reading apparatus according to claim 1, wherein the setting receiving unit notifies the user of reading settings which can be set for the second output format when the user receives the setting of permission of the use of the second output format.

6. An information processing apparatus communicably connected to an image reading apparatus, including:
at least one processor; and
a memory storing instructions that, when executed by the at least one processor, causes the at least one processor to function as:
capabilities information acquisition unit configured to acquire capabilities information, including a plurality of reading settings, of the image reading apparatus, from the image reading apparatus;
a receiving unit configured to receive reading settings designated by a user according to the acquired capabilities information;
an instruction transmission unit configured to transmit an instruction including the reading settings received by the receiving unit, to the image reading apparatus; and
an image acquisition unit configured to acquire an image generated by the image reading apparatus according to the instruction, from the image reading apparatus,
wherein the receiving unit
fixes a selectable output format to the first output format and displays reading settings usable in the first output format, in a user- selectable state, in a case where the acquired capabilities information is first capabilities information including a first reading profile formed by reading settings usable in the first output format, and
sets the first output format and the second output format as selectable output formats, in a case where the acquired capabilities information is second capabilities information including a second reading profile formed by reading settings usable in a second output format which is a derivative format of the first output format and is more restricted in reading settings than the first output format, and displays the reading settings usable in the second output format in a user selectable state in a case where the second output format is selected.

7. An image processing system including an image reading apparatus and an information processing apparatus communicably connected to each other,
the information processing apparatus including:
at least one processor; and
a memory storing instructions that, when executed by the at least one processor, causes the at least one processor to function as:
a request unit configured to request capabilities information, including a plurality of reading settings, of the image reading apparatus, to the image reading apparatus;
a receiving unit configured to receive reading settings designated by a user according to the capabilities information acquiredby the request unit; and
an instruction transmission unit configured to transmit an instruction including the reading settings received by the receiving unit, to the image reading apparatus,
the image reading apparatus including:
at least one processor; and
a memory storing instructions that, when executed by the at least one processor, causes the at least one processor to function as:
a transmission unit configured to transmit capabilities information, including a plurality of reading settings, of the image reading apparatus, to the information processing apparatus, in response to a request by the request unit;
a reception unit configured to receive the instruction from the information processing apparatus;
an image reading unit configured to execute reading of an image according to the instruction received by the reception unit;
a first image generation unit configured to generate a first image converted in the first output format from the read image;
a second image generation unit configured to generate a second image converted in a second output format which is a derivative format of the first output format and is more restricted in reading settings than the first output format, from the read image; and
a setting receiving unit configured to receive from a user a setting of permission or no permission of use of the second output format with respect to reading of an image executed according to the instruction received by the reception unit,
wherein the transmission unit of the image reading apparatus
transmits, in a case where the setting received by the setting receiving unit is a setting of no permission of the use of the second output format, first capabilities information including a first reading profile formed by reading settings usable in the first output format, to the information processing apparatus, as the capabilities information; and
transmits, in a case where the setting received by the setting receiving unit is a setting of permission of the use of the second output format, second capabilities information including a second reading profile formed by reading settings usable in the second output format, to the information processing apparatus, as the capabilities information;
wherein the receiving unit of the information processing apparatus
fixes a selectable output format to the first output format and displays reading settings usable in the first output format, in a user- selectable state, in a case where the capabilities information acquired by the request unit is first capabilities information, and
sets the first output format and the second output format as selectable output formats, in a case where the capabilities information acquired by the request unit is the second capabilities information, and displays the reading settings usable in the second output format in a user selectable state in a case where the second output format is selected;
generates, in a case where the first output format is set in the instruction received by the reception unit, the first image by the first image generation unit, as a transmission image; and
generates, in a case where the second output format is set in the instruction received by the reception unit, the second image by the second image generation unit, as the transmission image.

8. A method of controlling an image reading apparatus communicably connected to an information processing apparatus, comprising:
transmitting capabilities information of the image reading apparatus including a plurality of reading settings, to the information processing apparatus;
receiving an instruction including a reading setting designated by a user according to the capabilities information transmitted by the transmitting, from the information processing apparatus;
executing reading of an image according to the instruction received by the receiving;
generating a first image converted in a first output format from the read image;
generating a second image converted in a second output format which is a derivative format of the first output format and is more restricted in reading settings than the first output format, from the read image; and
receiving from a user a setting of permission or no permission of use of the second output format with respect to reading of an image, which is to be executed according to the instruction received by the receiving,
wherein the transmitting includes:
transmitting, in a case where the setting received by the receiving is a setting of no permission of the use of the second output format, first capabilities information including a first reading profile formed by reading settings usable in the first output format, to the information processing apparatus, as the capabilities information,
transmitting, in a case where the setting received by the receiving is a setting of permission of the use of the second output format, second capabilities information including a second reading profile formed by reading settings usable in the second output format, to the information processing apparatus, as the capabilities information,
generating, in a case where the first output format is set in the instruction received by the receiving, the first image, as a transmission image, and
generating, in a case where the second output format is set in the instruction received by the receiving, the second image, as the transmission image.

9. A method of controlling an information processing apparatus communicably connected to an image reading apparatus, comprising:
acquiring capabilities information, including a plurality of reading settings, of the image reading apparatus, from the image reading apparatus;
receiving reading settings designated by a user according to the acquired capabilities information;
transmitting an instruction including the reading settings received by the receiving, to the image reading apparatus; and
acquiring an image generated by the image reading apparatus according to the instruction, from the image reading apparatus,
wherein the receiving includes:
fixing a selectable output format to the first output format and displaying reading settings usable in the first output format, in a user- selectable state, in a case where the acquired capabilities information is first capabilities information including a first reading profile formed by reading settings usable in the first output format, and
setting the first output format and the second output format as selectable output formats, in a case where the acquired capabilities information is second capabilities information including a second reading profile formed by reading settings usable in a second output format which is a derivative format of the first output format and is more restricted in reading settings than the first output format, and displaying the reading settings usable in the second output format in a user selectable state in a case where the second output format is selected.

10. A method of controlling an image processing system including an image reading apparatus and an information processing apparatus communicably connected to each other,
in the information processing apparatus,
requesting capabilities information, including a plurality of reading settings, of the image reading apparatus, to the image reading apparatus;
receiving reading settings designated by a user according to the capabilities information acquired by the requesting; and
transmitting an instruction including the reading settings received by the receiving, to the image reading apparatus, and
in the image reading apparatus,
transmitting capabilities information of the image reading apparatus including a plurality of reading settings, to the information processing apparatus in response to the request;
receiving the instruction from the information processing apparatus;
executing reading of an image according to the instruction received by the receiving;
generating a first image converted in a first output format from the read image;
generating a second image converted in a second output format which is a derivative format of the first output format and is more restricted in reading settings than the first output format, from the read image; and
receiving from a user a setting of permission or no permission of use of the second output format with respect to reading of an image, which is to be executed according to the instruction received by the receiving, and
wherein the transmitting includes:
transmitting, in a case where the setting received by the receiving is a setting of no permission of the use of the second output format, first capabilities information including a first reading profile formed by reading settings usable in the first output format, to the information processing apparatus, as the capabilities information;
transmitting, in a case where the setting received by the receiving is a setting of permission of the use of the second output format, second capabilities information including a second reading profile formed by reading settings usable in the second output format, to the information processing apparatus, as the capabilities information;
wherein the receiving includes
fixing a selectable output format to the first output format and displaying reading settings usable in the first output format, in a user- selectable state, in a case where the capabilities information acquired by the requesting is the first capabilities information;
setting the first output format and the second output format as selectable output formats, in a case where the capabilities information acquired by the requesting is the second capabilities information, and displaying the reading settings usable in the second output format in a user selectable state in a case where the second output format is selected;
generating, in a case where the first output format is set in the instruction received by the receiving, the first image by the generating of the first image, as a transmission image; and
generating, in a case where the second output format is set in the instruction received by the receiving, the second image by the generating of the second image, as the transmission image.
